(19) United States
(12) Patent Application Publication
(10) Pub. No.: US 2004/0156771 A1
(43) Pub. Date: Aug. 12, 2004

(54) Method of reducing carbon monoxide concentration

(75) Inventor: Maki Hoshino, Kawasaki-shi (JP)

Correspondence Address: FOLEY AND LARDNER, SUITE 500, 3000 K STREET NW, WASHINGTON, DC, 20007, US

(73) Assignee: NISSAN MOTOR CO., LTD.

(21) Appl. No.: 10/771,544

(22) Filed: Feb. 5, 2004

(30) Foreign Application Priority Data
Feb. 10, 2003 (JP) 2003-032798

(51) Int. Cl. B01D 53/62

(52) U.S. Cl. 423/247

(57) ABSTRACT

A method of reducing carbon monoxide concentration of mixed gas containing hydrogen, carbon monoxide and oxygen comprises a step of preparing a carbon monoxide removing device having a carbon monoxide concentration reducing catalyst in which a transition metal element is included and a carbon monoxide adsorption amount is adjusted from 0.1 to 3 mL/cat.g, and a step of supplying the mixed gas to the carbon monoxide removing device at a space velocity of 15000 to 300000 h⁻¹ and a temperature of 100 to 300° C.

### BACKGROUND OF THE INVENTION

1. Field of the Invention

The present invention relates to a method of reducing carbon monoxide concentration. More specifically, the present invention relates to a method of reducing carbon monoxide concentration to reduce carbon monoxide concentration in a mixed gas containing hydrogen, carbon monoxide and oxygen as an oxidizing agent.

2. Description of the Related Art

Polymer electrolyte fuel cells are expected to be employed as a mobile power source for automobiles and the like, since high current density can be obtained therefrom even under a relatively low temperature. Regarding a hydrogen source for the polymer electrolyte fuel cells, a system, in which pure hydrogen is used, has been mainly considered. When using pure hydrogen, there is no need for concern about having an influence on polymer electrolyte fuel cells due to carbon monoxide, and thus a simple system can be achieved.

Meanwhile, systems using hydrocarbons or alcohols, which are generally available and easy to handle, as a fuel source have also been considered. Reformed gas, which is obtained by reforming hydrocarbons or alcohols, contains carbon dioxide, water vapor and carbon monoxide in addition to hydrogen which is a main component thereof. The problem in using this kind of reformed gas as a hydrogen source is a decrease in a power output of polymer electrolyte fuel cells being caused by adsorption of carbon monoxide on platinum which is an electrode catalyst.

In order to solve this kind of problem due to adsorption of carbon monoxide, a technology for reducing carbon monoxide concentration in reformed gas has been required. Accordingly, adsorption purification, hydrogen permselective membranes and the like are considered. However, although these methods will exhibit a sufficient effect in a plant and the like, which can secure a sufficient scale, they are not suitable for a mobile power source for automobiles and the like. This is because the volume for mounting therein is limited, and thus it is essential to downsize the fuel cell system.

By contrast, a method of selectively oxidizing carbon monoxide has been proposed, in which carbon monoxide is oxidized and removed by introducing a small amount of oxidizing agents in the presence of a catalyst. The catalyst is made of a carrier on which a noble metal such as platinum or ruthenium is supported. In order to oxidize and remove carbon monoxide, 0.5 moles of oxygen is the stoichiometrically required per mole of carbon monoxide. Nevertheless, slightly more oxygen than stoichiometrically required amount is actually introduced, thereby oxidizing and removing carbon monoxide down to a predetermined concentration.

However, in the method of oxidizing and removing carbon monoxide, heat is generated as the method utilizes oxidation reaction of carbon monoxide, and the catalyst temperature is increased due to the heat generation. An unfavorable reaction, e.g. reverse shift reaction (CO₂+H₂→CO+H₂O) may occur due to this temperature increase, thus increasing the carbon monoxide concentration. This is because the carbon monoxide concentration at each temperature is determined by the equilibrium between the reverse shift reaction (CO₂+H₂→CO+H₂O) and shift reaction (CO+H₂O→CO₂+H₂). Incidentally, in the region where the temperature is even higher, a methanation reaction (CO+3H₂→CH₄+H₂O) occurs consuming hydrogen that serves as fuel for fuel cells, even though the carbon monoxide concentration can be reduced by this reaction.

Accordingly, as a method of oxidizing and removing carbon monoxide contained in this kind of fuel reformed gas, a method of selectively oxidizing and removing carbon monoxide in the presence of a catalyst has been proposed. Particularly, in a polymer electrolyte fuel cell system expected as a mobile power source for automobiles and the like, it is required to reduce carbon monoxide concentration down to a ppm order in the reformed gas, which is obtained by reforming fuel and is mainly composed of hydrogen. Moreover, in accordance with the emission control being strengthened, it is also required to reduce carbon monoxide contained in exhaust gas of an internal combustion engine as much as possible. The preferred catalyst to be used in this kind of method of reducing carbon monoxide concentration is one capable of selectively oxidizing and removing carbon monoxide with smaller amount of oxygen introduced in the presence of a great deal of hydrogen.

Various kinds of catalysts have been known as a catalyst to promote selective oxidation reaction of carbon monoxide. For example, a catalyst using an alloy of platinum and ruthenium, which are a noble metal element and transition metal element, is disclosed (see Japanese Patent Application Laid-Open No. 2001-224965). In this conventional technology, the above alloy is supported on a base material having a specific lattice spacing (for example, mordenite or A-type zeolite), whereby the performance as a catalyst that selectively oxidizes carbon monoxide is improved.

### SUMMARY OF THE INVENTION

However, when an in-vehicle device for reducing carbon monoxide concentration is considered, there are cases where the performance to selectively reduce carbon monoxide concentration is insufficient, even when using the above-described catalyst for selectively oxidizing carbon monoxide. In particular, it has been difficult to effectively suppress side reaction in high temperature regions. Moreover, the cost thereof has been high because a noble metal is used as its main component.

In general, when an in-vehicle device for reducing carbon monoxide concentration is considered, the amount of gas flow which needs to be treated is large with respect to the catalyst volume. Hence, it is preferred that the space velocity (SV) thereof is equal to or more than 10000 h⁻¹, and, more preferably, SV=30000 h⁻¹ or more. Under a high SV condition like this, there are cases where sufficient catalytic activity cannot be obtained. Therefore, a catalyst and a method of reducing carbon monoxide concentration, which are capable of reducing carbon monoxide concentration even under a high SV condition, have been required. In addition, in order to oxidize and remove carbon monoxide, 0.5 moles of oxygen is stoichiometrically required per mole of carbon monoxide. However, in practice, more than 0.5 moles of oxygen is required. The excessively added oxygen reacts with hydrogen in the mixed gas, which leads to a reduction in efficiency. Accordingly, a catalyst which can reduce carbon monoxide concentration with smaller introduction amount of oxygen is preferable.

The present invention has been accomplished in order to solve the above problem. It is an object of the present invention to provide a method of reducing a carbon monoxide concentration in a mixed gas which contains hydrogen, carbon monoxide and oxygen, under a condition that an in-vehicle mounting is available. More specifically, it is an object of the present invention to provide a method of reducing carbon monoxide concentration to reduce a carbon monoxide concentration under high SV and high temperature conditions.

According to one aspect of the present invention, there is provided a method of reducing carbon monoxide concentration of mixed gas containing hydrogen, carbon monoxide and oxygen, comprising: preparing a carbon monoxide removing device having a carbon monoxide concentration reducing catalyst in which a transition metal element is included and a carbon monoxide adsorption amount is adjusted from 0.1 to 3 mL/cat.g; and supplying the mixed gas to the carbon monoxide removing device at a space velocity of 15000 to 300000 h⁻¹ and a temperature of 100 to 300° C.

### BRIEF DESCRIPTION OF THE DRAWINGS

The invention will now be described with reference to the accompanying drawings wherein;

FIG. 1 is a view showing an outline of a reforming system for a polymer electrolyte fuel cell; and

FIG. 2 is a view showing catalyst specifications and carbon monoxide adsorption amounts of catalysts of Examples and Comparative Examples.

### DETAILED DESCRIPTION OF THE PREFERRED EMBODIMENT

Hereinafter, description will be made of embodiments of the present invention with reference to the drawings.

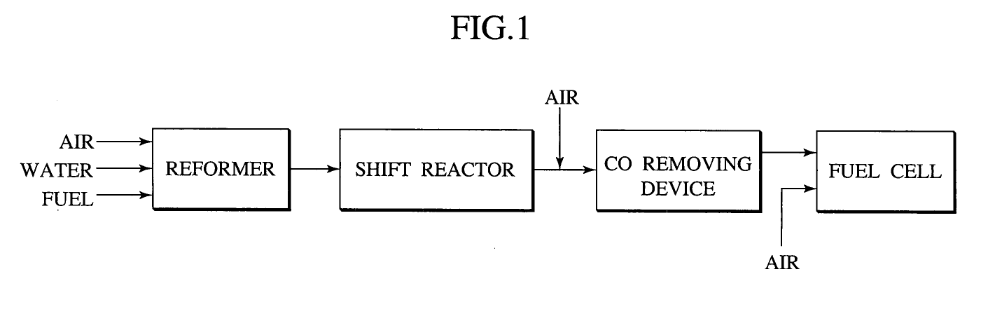

FIG. 1 shows a schematic configuration of a polymer electrolyte fuel cell system applying a method of reducing carbon monoxide concentration according to the present invention. For example, as illustrated in FIG. 1, a polymer electrolyte fuel cell system using gasoline as a fuel includes: a reformer; a shift reactor; a carbon monoxide removing device; and a polymer electrolyte fuel cell. The reformer produces hydrogen-containing reformed gas by autothermal reformation of gasoline. The shift reactor reduces carbon monoxide contained in the reformed gas by water gas shift reaction. The carbon monoxide removing device includes: a carbon monoxide concentration reducing catalyst for reducing carbon monoxide concentration; and means for introducing and mixing gas which contains oxygen as an oxidizing agent.

The reformer includes a reforming reaction section which houses a gasoline reforming catalyst (for example, rhodium (Rh) series catalyst). When the reformer is supplied with air, water and gasoline, the gasoline reforming catalyst in the reforming reaction section causes the autothermal reaction to proceed. In this way, the reformer produces reformed gas which contains hydrogen, and sends out the gas to the shift reactor. Generally, this reaction is conducted at the temperature of 350 to 850° C.

The shift reactor includes a water gas shift reaction section which houses a shift catalyst (for example, platinum (Pt) series or Cu—ZnO series catalyst). Upon receiving the gas from the reformer, the shift reactor allows the water gas shift reaction to proceed, thereby reducing the carbon monoxide concentration therein. Thus, the shift reactor produces a reformed gas with an increased hydrogen concentration, and sends out the gas to the carbon monoxide removing device. The above reaction is conducted at the temperature of 150 to 400° C. in general.

Meanwhile, the carbon monoxide removing device includes carbon monoxide concentration reducing section which houses the carbon monoxide concentration reducing catalyst (for example, Pt series or ruthenium (Ru) series catalyst). The carbon monoxide removing device introduces and mixes gas which contains oxygen as an oxidizing agent in the reformed gas. Accordingly, carbon monoxide in the reformed gas is oxidized and converted into carbon dioxide. The carbon monoxide removing device then sends out hydrogen-rich reformed gas to the fuel cell.

In addition, the polymer electrolyte fuel cell includes a solid polymer electrolyte membrane interposed between an anode and a cathode, through which hydrogen ions are selectively permeated. Fuel gas (reformed gas) and oxidizing gas are supplied to the anode and cathode, respectively, whereby an electrochemical reaction occurs to generate electromotive force. Thus, electricity is generated. If carbon monoxide of predetermined concentration or more is contained in the reformed gas supplied into the anode, an electrode catalyst, which constitutes the anode, is poisoned. Hence, performance of the fuel cell cannot be exhibited sufficiently. Since the polymer electrolyte fuel cell is usually made to operate at the temperature between 80 and 100° C., a significant influence on the performance thereof will be observed in general if the carbon monoxide concentration therein exceeds 100 ppm.

The temperature of the shift reaction section is typically between 200 and 400° C. Therefore, the outlet gas temperature of the shift reactor is supposed to be between 150 and 350° C. Accordingly, it is expected that the inlet gas temperature of the carbon monoxide removing device will be in a range from 100 to 300° C.

The carbon monoxide concentration in the reformed gas is an equilibrium concentration at the outlet gas temperature, if the amount of the shift catalyst is sufficient. In the case where the amount of the shift catalyst is not sufficient, the carbon monoxide concentration therein does not become an equilibrium concentration, and becomes higher than the equilibrium concentration. The lower the temperature is, the lower the carbon monoxide concentration is in the shift reaction. Since the reaction speed is remarkably decreased when it becomes 200° C. or less, the temperature is usually adjusted in a range whose lower limit is 200° C. The expected carbon monoxide concentration in the foregoing temperature range (150-350° C.) of the reformed gas is 0.1 to 2%.

The oxygen concentration in the reformed gas is preferably 0.5 to 1.5 molar times the foregoing carbon monoxide concentration. If it is less than 0.5 molar times, oxygen is insufficient stoichiometrically. Therefore, carbon monoxide concentration cannot be decreased. On the other hand, if it is more than 1.5 molar times, the oxygen will react with the hydrogen in the mixed gas, thus reducing the efficiency of hydrogen production.

Moreover, in the above polymer electrolyte fuel cell system, the amount of gas flow which needs to be treated is large with respect to the catalyst volume. Hence, it is preferred that the space velocity (SV) of the mixed gas supplied to the carbon monoxide removing device is within a range from 15000 to 300000 h⁻¹. If the space velocity is less than 15000 h⁻¹, the catalyst volume becomes too large, so that it is difficult to load the catalyst on the vehicle. If the space velocity is more than 300000 h⁻¹, the performance of the catalyst is insufficient.

Thus, the present invention is a method of reducing carbon monoxide concentration in a mixed gas containing hydrogen, carbon monoxide and oxygen. The method of reducing a carbon monoxide concentration includes a carbon monoxide removing device having a carbon monoxide concentration reducing catalyst in which a transition metal element is included, and a carbon monoxide adsorption amount is adjusted from 0.1 to 3 mL per gram of the catalyst (0.1 to 3 mL/cat.g). Moreover, the carbon monoxide removing device is supplied with the mixed gas at the space velocity (SV) of 15000 to 300000 h⁻¹ at the temperature of 100 to 300° C.

In general, when using a noble metal, e.g. platinum as a main component of the catalyst, the oxidation and removal of carbon monoxide needs to be performed under a high temperature, since the carbon monoxide adsorption power thereof is large. In the treatment under a high temperature, side reaction such as reverse shift reaction or the methanation reaction may proceed. Therefore, the carbon monoxide reduction rate may decrease, or hydrogen may be consumed. Although it can be considered that the oxidation and removal of carbon monoxide is performed under a relatively low temperature, there is a problem that carbon monoxide cannot be sufficiently removed since the adsorption amount thereof on the noble metal increases under a low temperature. Thus, even though a side reaction such as reverse shift reaction and methanation reaction may be suppressed by keeping the temperature low, the carbon monoxide concentration cannot be efficiently reduced, since the conversion of carbon monoxide into carbon dioxide does not sufficiently proceed.

Moreover, concerning the oxidation and removal of carbon monoxide, it is necessary that more than certain amount of carbon monoxide adsorbs on a metal. However, when a noble metal element is used as a main component, the oxidation reaction does not easily proceed, because sites thereof that can supply active oxygen necessary for the oxidation reaction decrease due to excessive adsorption of carbon monoxide thereon.

Therefore, if a transition metal, which has ability to oxidize carbon monoxide and relatively small power to adsorb carbon monoxide, is used as a main component of the catalyst instead of a noble metal, the amount of oxygen to be adsorbed thereon is not so large even at a relatively low temperature. Hence, carbon monoxide can be efficiently oxidized and removed even under a low temperature. Moreover, since sites thereof that can supply active oxygen do not decrease, active oxygen can be sufficiently supplied. Thus, a good balance between adsorption and oxidation of carbon monoxide can be maintained.

Furthermore, as described later, since oxidation reaction is exothermic reaction, temperature at which the catalyst exhibits its activity can be changed by adjusting the amount of carbon monoxide adsorbed by the catalyst. In addition, an operation temperature of the carbon monoxide removing device can be changed in accordance with the system. In the method of removing carbon monoxide according to the present invention, carbon monoxide can be efficiently oxidized and removed even under high SV and high temperature conditions, which are conditions imposed upon in-vehicle mounting, because a carbon monoxide concentration reducing catalyst, in which the carbon monoxide adsorption amount is adjusted, is disposed in the carbon monoxide removing device. Moreover, the catalyst can be selected in accordance with the reformed gas temperature at the outlet of the shift reactor, which fluctuates according to the system configuration, fuel type and fuel reformation performance. Thus, carbon monoxide can be oxidized and removed more efficiently.

Hereinafter, the present invention will be described in detail.

In the method of reducing a carbon monoxide concentration according to the present invention, a carbon monoxide concentration reducing catalyst is disposed in the carbon monoxide removing device. Herein, for the above reasons, it is preferred, to use a catalyst in which a transition metal element is included, and a carbon monoxide adsorption amount is adjusted from 0.1 to 3 mL per gram of the catalyst. If it is less than 0.1 mL/cat.g, the ability to oxidize carbon monoxide is not sufficient. If it is more than 3 mL/cat.g, side reaction under a high temperature cannot be suppressed enough. Note that the carbon monoxide adsorption amount is measured by a method mentioned in the later-described Examples.

The transition metal element (also referred to as a “first component” in this specification) of the catalyst for selectively oxidizing carbon monoxide, which is used in the present invention, is not particularly limited. Nevertheless, among the transition metal elements, at least one element selected from iron (Fe), cobalt (Co), nickel (Ni), copper (Cu), and manganese (Mn) is preferable in view of costs and their ability to oxidize carbon monoxide.

As for a carrier on which the foregoing first component is supported, any carrier is applicable as long as it is a refractory inorganic oxide carrier. However, it is preferred to use at least one selected from the group consisting of alumina (Al₂O₃), titania (TiO₂), silica (SiO₂) and zirconia (ZrO₂). This is because these are widely used as a catalyst carrier component and it is easy to obtain the raw materials thereof. Moreover, the method of manufacturing these carriers is simple. In addition, they are easy to handle, and it is easy to select a specific surface area thereof. In this invention, it is preferred to use one made of alumina due to its catalytic activity.

In the present invention, the transition metal element supported on the carrier is an element which has ability to oxidize carbon monoxide.

Various kinds of techniques such as an impregnation method, a coprecipitation method and a competitive adsorption method are applicable when these elements are supported on the carrier by using a catalyst preparation solution containing these elements. The treatment condition can be selected as appropriate according to the method. Normally, the carrier is brought into contact with the catalyst preparation solution for 1 minute to 10 hours at 20 to 90° C. For example, a catalyst powder may be obtained as follows: a catalyst preparation solution, in which a chemical compound containing the foregoing metal is dissolved or dispersed, is used; a carrier is impregnated with this solution; and the carrier impregnated with the solution is dried and baked. Any solvent that can dissolve a chemical compound containing the above element can be used. Examples thereof include alcohols, ethers, carboxylic acids and the like as well as water.

With regard to the drying method, air drying, an evaporation to dryness method, drying with a rotary evaporator or a spray drier and the like can be applied. The baking temperature is 200 to 1000° C. and the baking time is 30 to 480 minutes.

The catalyst used in the present invention may be one made as follows: at least one element selected from platinum, ruthenium or rhodium, which are noble metal elements, or lanthanum, neodymium, cerium or praseodymium, which are rare-earth elements, is further supported on the carrier (the element is also referred to as a “second component” in this specification). This is because it becomes easy to adjust the carbon monoxide adsorption amount of the catalyst when these elements are added. Moreover, if a noble metal element is used as the second component, a carbon monoxide concentration reducing activity of the catalyst at a lower temperature can be improved. Thus, carbon monoxide concentration can be reduced in a wide range of temperature. Therefore, it is favorable. Meanwhile, if a rare-earth element is used as the second component, carbon monoxide concentration can be reduced with a smaller amount of oxygen introduced. Hence, it is also favorable.

The amount of these second components to be supported is not particularly limited. However, it is preferable if the amount of the second component is set within a range where a desired carbon monoxide adsorption amount can be obtained. For example, it is preferable that the amount is within a range from 0.05 to 0.2 molar times the amount of the first component, since the carbon monoxide adsorption amount of the catalyst can be adjusted in a range from 0.1 to 3 mL/cat.g according to the above amount. Note that the amounts of the first and second components to be supported are calculated in terms of an amount of metal in the catalyst.

Moreover, the first and second components can be supported on the carrier simultaneously or separately. When the second component is supported separately, the carrier on which the first component is supported may be impregnated with a solvent, in which a chemical compound containing the second component is dissolved or dispersed, and baked thereafter. Note that various kinds of techniques such as a coprecipitation method and a competitive adsorption method can be applied other than this impregnation method.

In the present invention, a catalyst whose carbon monoxide adsorption amount is adjusted from 0.1 to 3 mL/cat.g is used. To be more specific, the catalyst can be produced using the following method. That is, on a carrier, at least one transition metal element selected from iron, cobalt, nickel, copper, and manganese is supported as a first component. Moreover, at least one element selected from platinum, ruthenium or rhodium, which are noble metal elements, or lanthanum, neodymium, cerium or praseodymium, which are rare-earth elements, is supported on the carrier as a second component. Then, the carrier is baked. Herein, it is preferred that the carrier is baked at the baking temperature of 500 to 800° C. In the case where two or more elements are supported as the second component, the second component may contain a noble metal element and rare-earth element at the same time.

With respect to salts, which are used as a raw material for the first and second components, it is preferred that one which can be dissolved in water, ethanol or the like is used. Examples thereof are nitrate, acetate, carbonate, etc.

Note that the method of preparing a catalyst, in which the carbon monoxide adsorption amount is adjusted from 0.1 to 3 mL/cat.g, is not limited to the foregoing method. For instance, in addition to the above components, an inorganic acid such as sulfuric acid, hydrochloric acid, nitric acid, an organic acid such as citric acid, oxalic acid, tartaric acid, or an other metal such as alkali metal, alkaline-earth metal can be added.

When adjusting the particle size of metal components such as first and second components by the baking temperature and time, the baking temperature is set to 300 to 1000° C., and the baking time is set to 0.1 to 24 hours. Thus, the particle size can be adjusted. Generally, the particle size increases when baked at a higher temperature for a longer time.

According to the present invention, it has become clear that, when the carbon monoxide adsorption amount of the carbon monoxide concentration reducing catalyst decreases, the catalyst exhibits carbon monoxide concentration reducing activity well at a higher temperature. Therefore, according to the present invention, the carbon monoxide concentration can be efficiently reduced even at a high temperature. Hence, for example, the invention is advantageous also in the case of using reformed gas discharged from the shift reactor as reaction gas in the polymer electrolyte fuel cell system, since an operation to cool the reformed gas, a device therefor or the like is not necessary therein.

If the catalyst used in the present invention is an unshaped one such as a powder catalyst or granular catalyst, it may be used as a catalyst composition as it is. However, it is preferred that a catalyst composition is supported on a monolithic substrate so that it can be used as a monolithic catalyst. This is because it is easy to fill the catalyst in a catalyst filling section of the reformer if the monolithic substrate is used. Moreover, permeability of raw gas and reformed gas can be ensured by a honeycomb structure thereof. Furthermore, it is possible to protect the catalyst from heat or baking when the raw gas or the like is supplied, thereby prolonging the life of the catalyst as well as improving the catalytic activity.

As for the monolithic substrate, a honeycomb substrate (cordierite, 400 to 3000 cell/inch²), metallic porous base material (Ni—Cr, 20 pores/inch to 50 pores/inch, diameter of approximately 100 mm φ), ceramic porous base material (ceramics, 9 pores/inch to 30 pores/inch, diameter of approximately 75 mm φ) and the like can be listed, and any one of them may be used. The honeycomb substrate, metallic porous base material and ceramic porous base material are excellent against pressure loss, and the coating technique therefor is easy. Thus, they are favorable. Note that it is preferred that the cell width thereof is 0.01 to 10 mm, and the number of cells per liter is 100 to 10000, so that the above air permeability and catalytic activity can be secured.

The catalyst can be supported on a monolithic substrate as follows, for example: a carrier such as titania, zirconia, vanadia, alumina or ceria is attached to a monolithic substrate by impregnation or the like; the monolithic substrate is baked; and a transition metal element and noble metal element are supported on the baked monolithic substrate thereafter. By contrast, a catalyst powder may be prepared in advance, the catalyst powder being stirred and milled in 1 to 10 times of water, and thus catalyst slurry is prepared. Then, the catalyst slurry is applied on a monolithic substrate, and the monolithic substrate is dried and baked.

In the present invention, the preferred amount of the second component in a monolithic catalyst is 2 g or less per liter of the monolithic catalyst. This is because the performance to reduce carbon monoxide concentration is not decreased. In addition to this, even in the case where a noble metal element is used as the second component, carbon monoxide adsorption amount on the catalyst can be reduced at a low cost.

The present invention is a method of reducing carbon monoxide concentration of mixed gas containing hydrogen, carbon monoxide and oxygen. Herein, the mixed gas containing hydrogen, carbon monoxide and oxygen is not particularly limited, since the present invention can be applied as long as these components are contained. For example, reformed gas obtained by a reforming fuel which contains hydrocarbons is favorable, as the invention can be applied to the carbon monoxide removing device in the polymer electrolyte fuel cell system which is expected as a mobile power source for automobiles and the like. Meanwhile, also in the case of using exhaust gas of an internal combustion engine as the above mixed gas, the carbon monoxide concentration can be efficiently reduced.

Examples of the carbon monoxide concentration reducing catalyst used in the present invention will be described below. However, the catalyst of the present invention is not limited to the following.

### EXAMPLE 1

A catalyst preparation solution made by adding and dissolving iron (III) nitrate nonahydrate in a dinitrodiammine platinum solution (8.5 wt %) was used. Fe and Pt were impregnated with and supported on an alumina powder. Fe and Pt were supported so as to be 5 wt % (in terms of metal) and 1 wt % (in terms of metal) relative to a catalyst powder obtained, respectively. After being dried for four hours at 150° C., the above was baked for one hour at 500° C. to obtain a Fe-5% and Pt-1% supporting alumina catalyst powder.

Subsequently, the above Fe-5% and Pt-1% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 1 was obtained. Note that the slurry was applied so that the catalyst 1 becomes 200 g/L.

### EXAMPLE 2

A catalyst preparation solution made by adding and dissolving cobalt (II) acetate tetrahydrate in a dinitrodiammine platinum solution (8.5 wt %) was used. Co and Pt were impregnated with and supported on an alumina powder. Co and Pt were supported so as to be 5 wt % (in terms of metal) and 1 wt % (in terms of metal) relative to a catalyst powder obtained, respectively. After being dried for four hours at 150° C., the above was baked for one hour at 500° C. to obtain a Co-5% and Pt-1% supporting alumina catalyst powder.

Subsequently, the above Co-5% and Pt-1% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 2 was obtained. Note that the slurry was applied so that the catalyst 2 becomes 200 g/L.

### EXAMPLE 3

A catalyst preparation solution made by adding and dissolving nickel (II) nitrate hexahydrate in a dinitrodiammine platinum solution (8.5 wt %) was used. Ni and Pt were impregnated with and supported on an alumina powder. Ni and Pt were supported so as to be 5 wt % (in terms of metal) and 1 wt % (in terms of metal) relative to a catalyst powder obtained, respectively. After being dried for four hours at 150° C., the above was baked for one hour at 500° C. to obtain a Ni-5% and Pt-1% supporting alumina catalyst powder.

Subsequently, the above Ni-5% and Pt-1% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 3 was obtained. Note that the slurry was applied so that the catalyst 3 becomes 200 g/L.

### EXAMPLE 4

A catalyst preparation solution made by adding and dissolving Manganese (II) nitrate hexahydrate in a dinitrodiammine platinum solution (8.5 wt %) was used. Mn and Pt were impregnated with and supported on an alumina powder. Mn and Pt were supported so as to be 5 wt % (in terms of metal) and 1 wt % (in terms of metal) relative to a catalyst powder obtained, respectively. After being dried for four hours at 150° C., the above was baked for one hour at 500° C. to obtain a Mn-5% and Pt-1% supporting alumina catalyst powder.

Subsequently, the above Mn-5% and Pt-1% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 4 was obtained. Note that the slurry was applied so that the catalyst 4 becomes 200 g/L.

### EXAMPLE 5

A catalyst preparation solution made by adding and dissolving copper (II) nitrate hexahydrate in a dinitrodiammine platinum solution (8.5 wt %) was used. Cu and Pt were impregnated with and supported on an alumina powder. Cu and Pt were supported so as to be 5 wt % (in terms of metal) and 1 wt % (in terms of metal) relative to a catalyst powder obtained, respectively. After being dried for four hours at 150° C., the above was baked for one hour at 500° C. to obtain a Cu-5% and Pt-1% supporting alumina catalyst powder.

Subsequently, the above Cu-5% and Pt-1% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 5 was obtained. Note that the slurry was applied so that the catalyst 5 becomes 200 g/L.

### EXAMPLE 6

Fe and Rh were impregnated with and supported on an alumina powder as similar to Example 1, except that a rhodium nitrate solution (13.8 wt %) was used instead of the dinitrodiamine platinum solution (8.5 wt %). Fe and Rh were supported so as to be 5 wt % (in terms of metal) and 1 wt % (in terms of metal) relative to a catalyst powder obtained, respectively. After being dried for four hours at 150° C., the above was baked for one hour at 500° C. to obtain a Fe-5% and Rh-1% supporting alumina catalyst powder. Subsequently, the Fe-5% and Rh-1% supporting alumina catalyst powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 6 was obtained. Note that the slurry was applied so that the catalyst 6 becomes 200 g/L.

### EXAMPLE 7

Co and Rh were impregnated with and supported on an alumina powder as similar to Example 2, except that a rhodium nitrate solution (13.8 wt %) was used instead of the dinitrodiamine platinum solution (8.5 wt %). Co and Rh were supported so as to be 5 wt % (in terms of metal) and 1 wt % (in terms of metal) relative to a catalyst powder obtained, respectively. After being dried for four hours at 150° C., the above was baked for one hour at 500° C. to obtain a Co-5% and Rh-1% supporting alumina catalyst powder. Subsequently, the Co-5% and Rh-1% supporting alumina catalyst powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 7 was obtained. Note that the slurry was applied so that the catalyst 7 becomes 200 g/L.

### EXAMPLE 8

Ni and Rh were impregnated with and supported on an alumina powder as similar to Example 3, except that a rhodium nitrate solution (13.8 wt %) was used instead of the dinitrodiamine platinum solution (8.5 wt %). Ni and Rh were supported so as to be 5 wt % (in terms of metal) and 1 wt % (in terms of metal) relative to a catalyst powder obtained, respectively. After being dried for four hours at 150° C., the above was baked for one hour at 500° C. to obtain a Ni-5% and Rh-1% supporting alumina catalyst powder. Subsequently, the Ni-5% and Rh-1% supporting alumina catalyst powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 8 was obtained. Note that the slurry was applied so that the catalyst 8 becomes 200 g/L.

### EXAMPLE 9

Mn and Rh were impregnated with and supported on an alumina powder as similar to Example 4, except that a rhodium nitrate solution (13.8 wt %) was used instead of the dinitrodiamine platinum solution (8.5 wt %). Mn and Rh were supported so as to be 5 wt % (in terms of metal) and 1 wt % (in terms of metal) relative to a catalyst powder obtained, respectively. After being dried for four hours at 150° C., the above was baked for one hour at 500° C. to obtain a Mn-5% and Rh-1% supporting alumina catalyst powder. Subsequently, the Mn-5% and Rh-1% supporting alumina catalyst powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 9 was obtained. Note that the slurry was applied so that the catalyst 9 becomes 200 g/L.

### EXAMPLE 10

Cu and Rh were impregnated with and supported on an alumina powder as similar to Example 5, except that a rhodium nitrate solution (13.8 wt %) was used instead of the dinitrodiamine platinum solution (8.5 wt %). Cu and Rh were supported so as to be 5 wt % (in terms of metal) and 1 wt % (in terms of metal) relative to a catalyst powder obtained, respectively. After being dried for four hours at 150° C., the above was baked for one hour at 500° C. to obtain a Cu-5% and Rh-1% supporting alumina catalyst powder. Subsequently, the Cu-5% and Rh-1% supporting alumina catalyst powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 10 was obtained. Note that the slurry was applied so that the catalyst 10 becomes 200 g/L.

### EXAMPLE 11

Cu and Ru were impregnated with and supported on an alumina powder as similar to Example 10, except that a ruthenium nitrate solution (8.5 wt %) was used instead of the rhodium nitrate solution (13.8 wt %). Cu and Rh were supported so as to be 5 wt % (in terms of metal) and 1 wt % (in terms of metal) relative to a catalyst powder obtained, respectively. After being dried for four hours at 150° C., the above was baked for one hour at 500° C. to obtain a Cu-5% and Rh-1% supporting alumina catalyst powder. Subsequently, the Cu-5% and Rh-1% supporting alumina catalyst powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 11 was obtained. Note that the slurry was applied so that the catalyst 11 becomes 200 g/L.

### EXAMPLE 12

Cu and Pd were impregnated with and supported on an alumina powder as similar to Example 10, except that a palladium nitrate solution (5.2 wt %) was used instead of the rhodium nitrate solution (13.8 wt %). Cu and Pd were supported so as to be 5 wt % (in terms of metal) and 1 wt % (in terms of metal) relative to a catalyst powder obtained, respectively. After being dried for four hours at 150° C., the above was baked for one hour at 500° C. to obtain a Cu-5% and Pd-1% supporting alumina catalyst powder. Subsequently, the Cu-5% and Pd-1% supporting alumina catalyst powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 12 was obtained. Note that the slurry was applied so that the catalyst 12 becomes 200 g/L.

### EXAMPLE 13

Cu and La were impregnated with and supported on an alumina powder as similar to Example 10, except that lanthanum acetate was used instead of the rhodium nitrate solution (13.8 wt %). Cu and La were supported so as to be 5 wt % (in terms of metal) and 1 wt % (in terms of metal) relative to a catalyst powder obtained, respectively. After being dried for four hours at 150° C., the above was baked for one hour at 500° C. to obtain a Cu-5% and La-1% supporting alumina catalyst powder. Subsequently, the Cu-5% and La-1% supporting alumina catalyst powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 13 was obtained. Note that the slurry was applied so that the catalyst 13 becomes 200 g/L.

### EXAMPLE 14

Cu and Nd were impregnated with and supported on an alumina powder as similar to Example 13, except that neodymium acetate was used instead of lanthanum acetate. Cu and Nd were supported so as to be 5 wt % (in terms of metal) and 1 wt % (in terms of metal) relative to a catalyst powder obtained, respectively. After being dried for four hours at 150° C., the above was baked for one hour at 500° C. to obtain a Cu-5% and Nd-1% supporting alumina catalyst powder. Subsequently, the Cu-5% and Nd-1% supporting alumina catalyst powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 14 was obtained. Note that the slurry was applied so that the catalyst 14 becomes 200 g/L.

### EXAMPLE 15

Cu and Ce were impregnated with and supported on an alumina powder as similar to Example 13, except that cerium nitrate was used instead of lanthanum acetate. Cu and Ce were supported so as to be 5 wt % (in terms of metal) and 1 wt % (in terms of metal) relative to a catalyst powder obtained, respectively. After being dried for four hours at 150° C., the above was baked for one hour at 500° C. to obtain a Cu-5% and Ce-1% supporting alumina catalyst powder. Subsequently, the Cu-5% and Ce-1% supporting alumina catalyst powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 15 was obtained. Note that the slurry was applied so that the catalyst 15 becomes 200 g/L.

### EXAMPLE 16

Cu and Pr were impregnated with and supported on an alumina powder as similar to Example 13, except that praseodymium acetate was used instead of lanthanum acetate. Cu and Pr were supported so as to be 5 wt % (in terms of metal) and 1 wt % (in terms of metal) relative to a catalyst powder obtained, respectively. After being dried for four hours at 150° C., the above was baked for one hour at 500° C. to obtain a Cu-5% and Pr-1% supporting alumina catalyst powder. Subsequently, the Cu-5% and Pr-1% supporting alumina catalyst powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 16 was obtained. Note that the slurry was applied so that the catalyst 16 becomes 200 g/L.

### EXAMPLE 17

Co and Pt were impregnated with and supported on an alumina powder as similar to Example 2, except that the Pt supporting amount was set to be 0.5 wt % (in terms of metal), and a Co-5% and Pt-0.5% supporting alumina catalyst powder was thus obtained. Subsequently, the Co-5% and Pt-0.5% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 17 was obtained. Note that the slurry was applied so that the catalyst 17 becomes 200 g/L.

### EXAMPLE 18

Ni and Pt were impregnated with and supported on an alumina powder as similar to Example 3, except that the Pt supporting amount was set to be 0.5 wt % (in terms of metal), and a Ni-5% and Pt-0.5% supporting alumina catalyst powder was thus obtained. Subsequently, the Ni-5% and Pt-0.5% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 18 was obtained. Note that the slurry was applied so that the catalyst 18 becomes 200 g/L.

### EXAMPLE 19

Cu and Pt were impregnated with and supported on an alumina powder as similar to Example 5, except that the Pt supporting amount was set to be 0.5 wt % (in terms of metal), and a Cu-5% and Pt-0.5% supporting alumina catalyst powder was thus obtained. Subsequently, the Cu-5% and Pt-0.5% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 19 was obtained. Note that the slurry was applied so that the catalyst 19 becomes 200 g/L.

### EXAMPLE 20

Co and Pt were impregnated with and supported on an alumina powder as similar to Example 2, except that the Pt supporting amount was set to be 2 wt % (in terms of metal), and a Co-5% and Pt-2% supporting alumina catalyst powder was thus obtained. Subsequently, the Co-5% and Pt-2% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 20 was obtained. Note that the slurry was applied so that the catalyst 20 becomes 100 g/L.

### EXAMPLE 21

Ni and Pt were impregnated with and supported on an alumina powder as similar to Example 3, except that the Pt supporting amount was set to be 2 wt % (in terms of metal), and a Ni-5% and Pt-2% supporting alumina catalyst powder was thus obtained. Subsequently, the Ni-5% and Pt-2% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 21 was obtained. Note that the slurry was applied so that the catalyst 21 becomes 100 g/L.

### EXAMPLE 22

Cu and Pt were impregnated with and supported on an alumina powder as similar to Example 5, except that the Pt supporting amount was set to be 2 wt % (in terms of metal), and a Cu-5% and Pt-2% supporting alumina catalyst powder was thus obtained. Subsequently, the Cu-5% and Pt-2% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 22 was obtained. Note that the slurry was applied so that the catalyst 22 becomes 100 g/L.

### EXAMPLE 23

Co and Pt were impregnated with and supported on mordenite as similar to Example 2, except that mordenite was used instead of alumina as the carrier, and a Co-5% and Pt-1% supporting mordenite catalyst powder was thus obtained. Subsequently, the Co-5% and Pt-1% supporting mordenite powder, silica sol and water were poured into a magnetic ball mill pot, and mixed and milled for two hours to form a slurry. The slurry was applied on a honeycomb substrate, air-dried at 130° C., and baked for one hour at 400° C. Thus, a catalyst 23 was obtained. Note that the slurry was applied so that the catalyst 23 becomes 200 g/L.

### EXAMPLE 24

Co and Pt were impregnated with and supported on ZSM-5 as similar to Example 2, except that ZSM-5 was used instead of alumina as the carrier, and a Co-5% and Pt-1% supporting ZSM-5 catalyst powder was thus obtained. Subsequently, the Co-5% and Pt-1% supporting ZSM-5 powder, silica sol and water were poured into a magnetic ball mill pot, and mixed and milled for two hours to form a slurry. The slurry was applied on a honeycomb substrate, air-dried at 130° C., and baked for one hour at 400° C. Thus, a catalyst 24 was obtained. Note that the slurry was applied so that the catalyst 24 becomes 200 g/L.

### EXAMPLE 25

Co and Pt were impregnated with and supported on silica as similar to Example 2, except that silica was used instead of alumina as the carrier, and a Co-5% and Pt-1% supporting silica catalyst powder was thus obtained. Subsequently, the Co-5% and Pt-1% supporting silica powder, silica sol and water were poured into a magnetic ball mill pot, and mixed and milled for two hours to form a slurry. The slurry was applied on a honeycomb substrate, air-dried at 130° C., and baked for one hour at 400° C. Thus, a catalyst 25 was obtained. Note that the slurry was applied so that the catalyst 25 becomes 200 g/L.

### EXAMPLE 26

Co and Pt were impregnated with and supported on titania as similar to Example 2, except that titania was used instead of alumina as the carrier, and a Co-5% and Pt-1% supporting titania catalyst powder was thus obtained. Subsequently, the Co-5% and Pt-1% supporting titania powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 26 was obtained. Note that the slurry was applied so that the catalyst 26 becomes 200 g/L.

### EXAMPLE 27

Co and Pt were impregnated with and supported on zirconia as similar to Example 2, except that zirconia was used instead of alumina as the carrier, and a Co-5% and Pt-1% supporting zirconia catalyst powder was thus obtained. Subsequently, the Co-5% and Pt-1% supporting zirconia powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 27 was obtained. Note that the slurry was applied so that the catalyst 27 becomes 200 g/L.

### COMPARATIVE EXAMPLE 1

A catalyst preparation solution made by dissolving iron (III) nitrate nonahydrate was used. Fe was impregnated with and supported on an alumina powder. Fe was supported so as to be 5 wt % (in terms of metal) relative to a catalyst powder obtained. After being dried for four hours at 150° C., the above was baked for one hour at 500° C. to obtain a Fe-5% supporting alumina catalyst powder.

Subsequently, the Fe-5% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 28 was obtained. Note that the slurry was applied so that the catalyst 28 becomes 200 g/L.

### COMPARATIVE EXAMPLE 2

A catalyst preparation solution made by dissolving cobalt (II) acetate tetrahydrate was used. Co was impregnated with and supported on an alumina powder. Co was supported so as to be 5 wt % (in terms of metal) relative to a catalyst powder obtained. After being dried for four hours at 150° C., the above was baked for one hour at 500° C. to obtain a Co-5% supporting alumina catalyst powder.

Subsequently, the Co-5% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 29 was obtained. Note that the slurry was applied so that the catalyst 29 becomes 200 g/L.

### COMPARATIVE EXAMPLE 3

A catalyst preparation solution made by dissolving nickel (II) nitrate hexahydrate was used. Ni was impregnated with and supported on an alumina powder. Ni was supported so as to be 5 wt % (in terms of metal) relative to a catalyst powder obtained. After being dried for four hours at 150° C., the above was baked for one hour at 500° C. to obtain a Ni-5% supporting alumina catalyst powder.

Subsequently, the Ni-5% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 30 was obtained. Note that the slurry was applied so that the catalyst 30 becomes 200 g/L.

### COMPARATIVE EXAMPLE 4

A catalyst preparation solution made by dissolving manganese (II) nitrate hexahydrate was used. Mn was impregnated with and supported on an alumina powder. Mn was supported so as to be 5 wt % (in terms of metal) relative to a catalyst powder obtained. After being dried for four hours at 150° C., the above was baked for one hour at 500° C. to obtain a Mn-5% supporting alumina catalyst powder.

Subsequently, the Mn-5% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 31 was obtained. Note that the slurry was applied so that the catalyst 31 becomes 200 g/L.

### COMPARATIVE EXAMPLE 5

A catalyst preparation solution made by dissolving copper (II) nitrate hexahydrate was used. Cu was impregnated with and supported on an alumina powder. Cu was supported so as to be 5 wt % (in terms of metal) relative to a catalyst powder obtained. After being dried for four hours at 150° C., the above was baked for one hour at 500° C. to obtain a Cu-5% supporting alumina catalyst powder.

Subsequently, the Cu-5% supporting alumina powder, alumina sol and water were poured into a magnetic ball mill pot, and mixed and milled for two hours to form a slurry. The slurry was applied on a honeycomb substrate, air-dried at 130° C., and baked for one hour at 400° C. Thus, a catalyst 32 was obtained. Note that the slurry was applied so that the catalyst 32 becomes 200 g/L.

The carbon monoxide adsorption amounts of the obtained catalysts were measured by a pulse method. A full automatic CO gas adsorption amount analyzer (made by OHKURA RIKEN Co., Ltd.) was used as a measurement device. The measurement was performed in accordance with the following procedure.

1) heating up to 400° C. at 10° C./min. in a flow of 100% He gas;

2) oxidation treatment in a flow of an 10% O₂/He balance gas at 400° C. for 15 minutes;

3) purging by 100% He gas for 5 minutes;

4) reduction treatment in a flow of 10% H₂/He balance gas at 400° C. for 15 minutes;

5) cooled down to 50° C. in a flow of 100% He gas; and

6) flowing 10% CO/He balance gas in a pulsing manner and obtaining the carbon monoxide adsorption amount.

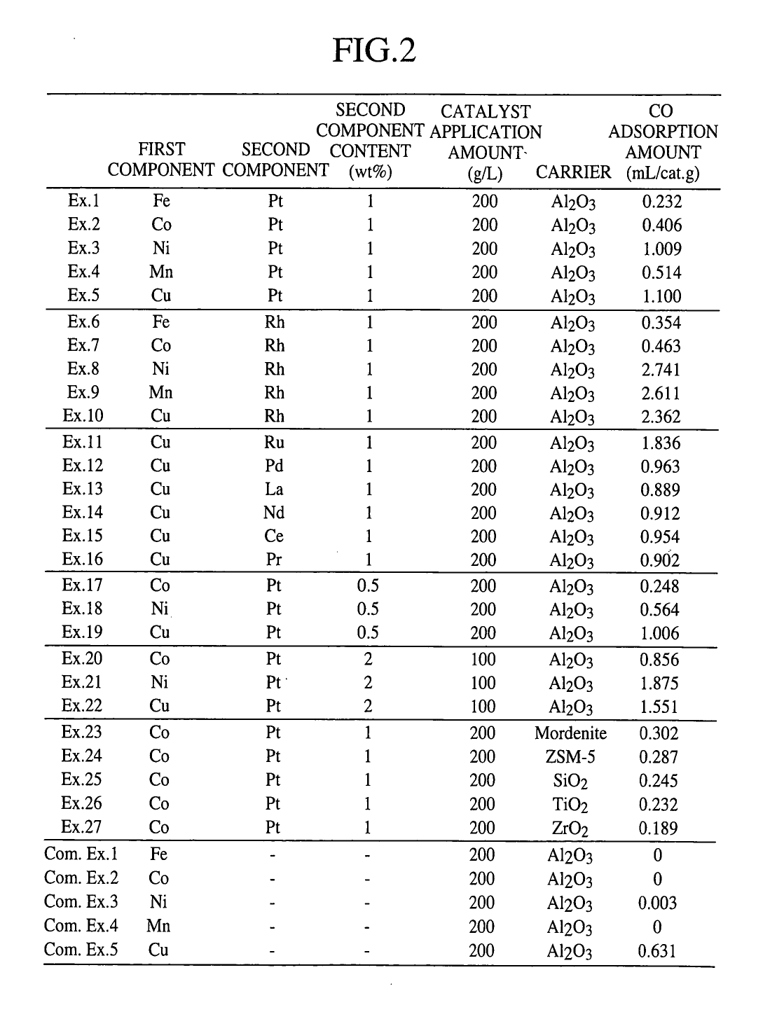

The carbon monoxide adsorption amounts and catalyst specifications of respective catalysts are shown in FIG. 2.

Each of the catalysts was evaluated by use of mixed gas of H₂ 40%, CO₂ 14%, CO 0.8%, O₂ 0.8%, H₂O 27% and N₂ as model gas. The model gas was supplied so that the gas flow amount (cm³/h)/catalyst volume (cm³) became approximately 100000 h⁻¹ (dry gas base) with respect to the catalyst. Then a reaction temperature was changed, and outlet CO concentration was measured.

The catalyst, in which the carbon monoxide adsorption amount was approximately 0.4 to 3 mL/cat.g, exhibited carbon monoxide concentration reducing activity at 100 to 200° C. By contrast, the catalyst whose carbon monoxide adsorption amount was approximately 0.4 mL/cat.g or less exhibited carbon monoxide concentration reducing activity at 200° C. or higher.

The entire content of a Japanese Patent Application No. P2003-32798 with a filing date of Feb. 10, 2003 is herein incorporated by reference.

Although the invention has been described above by reference to certain embodiments of the invention, the invention is not limited to the embodiments described above will occur to these skilled in the art, in light of the teachings. The scope of the invention is defined with reference to the following claims.

What is claimed is:

1. A method of reducing carbon monoxide concentration of mixed gas containing hydrogen, carbon monoxide and oxygen, comprising:
preparing a carbon monoxide removing device having a carbon monoxide concentration reducing catalyst in which a transition metal element is included and a carbon monoxide adsorption amount is adjusted from 0.1 to 3 mL/cat.g; and
supplying the mixed gas to the carbon monoxide removing device at a space velocity of 15000 to 300000 h⁻¹ and a temperature of 100 to 300° C.

2. A method of reducing carbon monoxide concentration according to claim 1,
wherein the carbon monoxide concentration in the mixed gas is 0.1 to 2 vol % and oxygen concentration in the mixed gas is 0.5 to 1.5 molar times the carbon monoxide concentration.

3. A method of reducing carbon monoxide concentration according to claim 1,
wherein the carbon monoxide concentration reducing catalyst contains at least one element selected from the group consisting of iron, cobalt, nickel, copper, and manganese as the transition metal element which is a first component, and
the carbon monoxide concentration reducing catalyst contains a second component, and a contained amount of the second component is 0.05 to 0.2 molar times a contained amount of the first component.

4. A method of reducing carbon monoxide concentration according to claim 3,
wherein the second component is a noble metal element.

5. A method of reducing carbon monoxide concentration according to claim 4,
wherein the noble metal element is at least one element selected from the group consisting of platinum, ruthenium and rhodium.

6. A method of reducing carbon monoxide concentration according to claim 3,
wherein the second component is a rare-earth element.

7. A method of reducing carbon monoxide concentration according to claim 6,
wherein the rare-earth element is at least one element selected from the group consisting of lanthanum, neodymium, cerium and praseodymium.

8. A method of reducing carbon monoxide concentration according to claim 3,
wherein the carbon monoxide concentration reducing catalyst is a monolithic catalyst, and the contained amount of the second component is 2 g or less per liter of the monolithic catalyst.

9. A method of reducing carbon monoxide concentration according to claim 1,
wherein the mixed gas is reformed gas obtained by reforming a fuel containing a hydrocarbon.

10. A method of reducing carbon monoxide concentration according to claim 1,
wherein the mixed gas includes exhaust gas of an internal combustion engine.
